(19) United States
(12) Patent Application Publication
(10) Pub. No.: US 2026/0235877 A1
(43) Pub. Date: Aug. 13, 2026

(54) HEAD MOUNTED DISPLAY DEVICE AND SYSTEM FOR REALTIME GUIDANCE

(71) Applicant: ARSpectra S.à.r.l., Foetz (LU)

(72) Inventors: Cédric SPAAS, Foetz (LU); Hassan AFZAL, Foetz (LU); Augusto Wladimir DE LA CADENA, Foetz (LU)

(21) Appl. No.: 19/156,443

(22) PCT Filed: Feb. 14, 2024
(86) PCT No.: PCT/EP2024/053762

§ 371 Date: Aug. 14, 2025

(30) Foreign Application Priority Data
Feb. 14, 2023 (LU) LU503485
May 5, 2023 (LU) LU504130

(51) Int. Cl. G02B 27/01; G02B 27/00; G06F 1/16; G06F 3/04815; H04N 13/117; H04N 13/239; H04N 13/254; H04N 13/344; H04N 13/383

(52) U.S. Cl. CPC G02B 27/0172; G02B 27/0093; G06F 1/163; G06F 3/04815; H04N 13/117; H04N 13/239; H04N 13/254; H04N 13/344; H04N 13/383; G02B 2027/0138; G02B 2027/014; G02B 2027/0141

(57) ABSTRACT

A head mounted display (HMD) device and an image-based guidance system are disclosed. The HMD has sensors imaging a scene as pixel data and a display outputting a graphical user interface (GUI). The HMD has one or more parallel processing modules, each configured with a plurality of pixel-respective data processing threads, which receives the pixel data from the sensors, filters same to segregate pixel data representative of an optical contrasting agent applied to at least one target in the scene, and computes two-dimensional (2D) pixel coordinate data from segregated pixel data. Data processing means of the HMD transforms 2D pixel coordinate data by reference to a first geometrical dataset into three-dimensional (3D) coordinate data representative of the or each target relative to the device, generates 3D guidance data by reference to one or more further geometrical datasets, each representative of a respective target in the scene, and outputs the 3D guidance data to the GUI.

### FIELD OF INVENTION

The invention belongs to the field of head mounted display (‘HMD’) devices implementing an image-based guidance functionality.

### BACKGROUND TO INVENTION

Image-based guidance systems improve the efficiency and accuracy of their users during precise manipulations. An example manipulation is the insertion of a needle-like surgical tool within a patient at specific location in a specific orientation. Such procedures typically require high positional precision, wherein image-based guidance systems help achieve the requisite degree of accuracy through detecting, tracking and rendering both current and desired tool poses by reference to a field of view that includes the manipulating environment, e.g. a surgical site, on a display for the system user to compare and adjust.

The technical challenge is substantial, because the tool needs to be accurately detected in image data amongst the scene clutter within the camera field of view, likewise the tool pose by reference to the six mechanical degrees of freedom of movement (‘6DoF’) in three-dimensional space (‘3D’), with sub-millimetre precision. Computed poses, respectively actual and desired tool poses, then need to be accurately rendered on a display, in order to provide guidance to the user during the procedure, all substantially in real time, i.e. with minimal latency between sensor input and display output.

Many image-based tool guidance systems exist, such as the Surgical Navigation Systems YR02143™ manufactured by Kalstein® and the StealthStation™ S8 Surgical Navigation System manufactured by Medtronic®. Such solutions track the spatial position and orientation of targets with fiducial markers, e.g. QR codes, or active markers, e.g. light-emitting diodes (LEDs) or passive markers, e.g. reflective dots that are applied to the surgical tool and on or near the tool target. Markers are detected in high resolution images acquired by optical systems that are typically placed in a fixed position overlooking the surgical theatre, in the most unobtrusive position to the surgeon and surgery site. The three-dimensional (3D) positions of markers are triangulated from their detections in the images, whereby the current 3D position and 3D orientation of the tool and the target are determined in the optical system's reference coordinate system. The results are then rendered on a display monitor, to which the tool user must continuously refer for adjusting the tool position and orientation towards the desired location. This continuous comparison is subjective, error-prone, and time-inefficient.

Alternative image-based tool guidance systems have been proposed to try and mitigate these disadvantages, by M. A. Lin et al. (“HoloNeedle: Augmented-reality Guidance System for Needle Placement Investigating the Advantages of 3D Needle Shape Reconstruction”, IEEE Robotics and Automation Letters, July 2018) and T. Kuzhagaliyev et al. (“Augmented reality needle ablation guidance tool for irreversible electroporation in the pancreas”, Proceedings SPIE 10576, Medical Imaging 2018: Image-Guided Procedures, Robotic Interventions and Modelling, March 2018), that are based upon the use of augmented reality (AR) head mounted display (HMD) devices for providing the HMD wearer, with guidance about targets, e.g. a tool and its destination in a surgery site, within their line of sight.

In such systems, the current and desired positions of the tool, sometimes also pre-acquired scans of the surgery site and aligning guidance between current and desired positions of the tool, are rendered to the display of the HMD, which advantageously removes the need for the wearer to consult a display monitor away from the operating table, thus decreasing error risks. However, complexity is added by the motion of the HMD AR headset relative to the fixed optical system's reference coordinate system, wherein the position and orientation of the HMD also needs to be accurately determined and tracked, e.g. with a QR code or other marker. In these systems, the AR HMD device is invariably used as a simple display, with image processing, pose extraction and calculating, and other complex, guidance-related image and data processing performed by external computing resources, to which the HMD is tethered. This is because AR HMDs have insufficient data processing means onboard to provide the requisite amount of image processing, complex calculations and rendering for maintaining real-time levels of latency.

In a more recent alternative proposed by B. J. Park et al. (“Augmented reality improves procedural efficiency and reduces radiation dose for CT-guided lesion targeting: a phantom study using HoloLens 2”, Sci Rep 10, 18620 (2020); https://doi.org/10.1038/s41598-020-75676-4), researchers demonstrated that using AR HMDs to provide holographic guidance for needle navigation improves the efficiency of needle-based procedures. However this approach, based upon the Vuforia™ software development kit, still only superimposes a desired location for a tool in 3D onto a surface, leaving the HMD wearer to align the physical needle tool in their hand, or another's, with the projected graphics, as the position of the actual needle is not tracked wherein the registration and accuracy of the current needle position relative to the desired position is not estimated nor calculated. Improvements to such approaches that may be expected from advances in miniaturised processing components and power optimisation are mitigated by the trend in equipping HMD models with cameras of ever-increasing frame rates and ever-wider fields of view, with correspondingly-increased volume and density of image data processed therein.

Conclusively, proven image-based navigation techniques rely upon multiple distinct hardware systems for optical capture and tracking, data processing and rendering, resulting in costly and complex systems with non-trivial data communication and synchronisation requirements, all defining multiple potential points of failure. Recent image-based navigation techniques attempting to simplify such systems require trade-offs between accuracy, ergonomy and useability, in order to meet minimal latency requirements.

Accordingly, there is a requirement for an HMD device, which mitigates at least some of the shortcomings of these image-based guidance techniques of the prior art.

### SUMMARY OF INVENTION

Aspects of the invention are set out in the accompanying claims, respectively aimed at various embodiments of a head mounted display (HMD) device, various embodiments of a distributed imaging system based on the head mounted display (HMD) device, and various embodiments of a method of distributing image data in a network with the system.

The inventive concept lies in reducing substantially the volume of image data which a portable display device needs to process for providing image-based guidance in real time. Recent technical improvements in hardware acceleration of embedded systems, in particular in small and power-efficient parallel processing modules, are leveraged to pre-process high entropy image data captured with high-resolution imaging sensors, for reducing same into low entropy image data that preserves semantic content useful for guidance purposes. Such low entropy image data is input to other processing modules for geometrical and rendering computations, the technique of the invention providing a low latency image processing technique, which is particularly suitable for lightweight head-mounted display (‘HMD’) devices.

Accordingly, in a first aspect, the present invention provides a head mounted display (HMD) device comprising imaging means generating pixel data representative of a scene in use; display means outputting a graphical user interface in use; power means, data storage means storing geometrical datasets and data processing means operably interfaced with the imaging means and the display means, wherein the data processing means comprises at least one parallel processing module configured with a plurality of pixel-respective data processing threads, adapted to filter pixel data with a predetermined value to segregate first pixel data from second pixel data, wherein the first pixel data is representative of an optical contrasting agent applied to at least one target in the scene, and compute two-dimensional (2D) pixel coordinate data from segregated first pixel data; and wherein the data processing means is further adapted to transform the computed 2D pixel coordinate data by reference to a first geometrical dataset representative of at least one coordinate system originating at the device into three-dimensional (3D) coordinate data representative of the or each target relative to the device, and generate 3D guidance data according to the 3D coordinate data, by reference to one or more further geometrical datasets, each representative of a respective target in the scene; wherein the data processing means is further adapted to output the 3D guidance data to the graphical user interface.

The technique of the invention accordingly provides a low latency image processing technique, which is particularly suitable for lightweight head-mounted display (‘HMD’) devices. With reference to trade-offs between accuracy, ergonomy and useability in order to meet minimal latency requirements, the technique of the invention advantageously mitigates the data processing overhead associated with cameras of ever-higher resolutions and ever-wider fields of views, that are desirable for accurate target(s) capture in realtime, by filtering out captured image data that is redundant for guidance purposes, whilst preserving semantic image data that is of prime importance to guidance purposes.

In embodiments of the HMD device, the data processing means may be further adapted to transform the computed 2D pixel coordinate data into 3D pixel coordinate data by triangulating the 2D pixel coordinate data by reference to the first geometrical dataset. Alternatively the data processing means may be further adapted to transform the computed 2D pixel coordinate data into 3D pixel coordinate data by solving for 3D rotation and translation based on the 2D pixel coordinate data.

In embodiments of the HMD device, an origin of the at least one coordinate system originating at the device may be selected from an aperture of the imaging means, a display unit of the display means and one of the HMD wearer's eyes. In variants of such embodiments, the first geometrical dataset may comprise a calibrated set of transformations between coordinate systems originating respectively at the aperture of the imaging means, the display unit and the HMD wearer's eye.

Subject to the operational requirements of embodiments and to the technical capabilities of components available to implement them, the imaging means may be implemented as a single imaging sensor, as a pair of imaging sensors optionally in a stereoscopic arrangement, in a hybrid combination of high- and low-resolution imaging sensors, in a hybrid combination of imaging sensor(s) and distance sensor(s), e.g. of a time-of-flight, event-based or echolocation type.

In embodiments of the HMD device, at least one target in the scene may be a tool in use by or proximate the HMD wearer, and at least one amongst the one or more further geometrical datasets comprises a three-dimensional model representative of the tool. Alternatively, or additionally, the target may be a marker defining a location in the scene, and at least one amongst the one or more further geometrical datasets comprises a three-dimensional model representative of the marker. Alternatively still, the target may be a biological marker, for instance subcutaneous tissue rendered fluorescent by injection or ingestion of the optically contrasted agent.

In variants of such embodiments particularly adapted to a scene comprising at least two targets, the data processing means may be further adapted to generate display data representative of a pathway between the tool and the marker in the scene when generating the 3D guidance display data.

Embodiments of the HMD device may be devised for use with passive optical contrasting agents and may thus further comprise a switchable source of illumination operably connected to the power means for supply, configured to excite the optical contrasting agent in the scene.

In embodiments of the HMD device, the data processing means may further comprise a graphical processing unit (‘GPU’) programmed to generate 3D guidance display data according to the 3D guidance data, by reference to the one or more further geometrical datasets; wherein the data processing means may be further adapted to output the 3D guidance display data to the graphical user interface.

Embodiments of the HMD device may be devised to enhance accuracy of display, wherein the data processing means is further adapted to determine a mismatch between the generated 3D guidance display data and the HMD wearer eye based on a distance measurement and a position of the wearer's eye, and to adjust a position of the generated guidance display data in the graphical user interface according to the determined mismatch. The distance measurement may be performed based on stereoscopic image data and/or performed with an optional distance sensor of the HMD device.

Embodiments of the HMD device may be devised to enhance optical accuracy for the wearer and may thus further comprise a pair of eye imaging sensors each generating eye pixel data representative of a respective eye of the HMD wearer in use and at least a second parallel processing module configured and operating according to the inventive principle disclosed herein. The second parallel processing may accordingly be configured with a plurality of eye pixel-respective data processing threads, adapted to filter eye pixel data with a predetermined value to segregate first eye pixel data from second eye pixel data, wherein the first eye pixel data is representative of at least a portion of the or each wearer's eye; and to compute two-dimensional (2D) eye pixel coordinate data from the segregated first eye pixel data. The data processing means may accordingly be further adapted to triangulate 2D eye pixel coordinate data received from the or each second data parallel processing module by reference to the first geometrical dataset, thereby generating three-dimensional (3D) eye coordinate data representative of the wearer's eye focus relative to the device, transform the 3D coordinate data by reference to the 3D eye coordinate data, and generate the 3D guidance data according to transformed 3D coordinate data.

Variants of such embodiments may be devised to optimise the usage of computing resources when generating display data, wherein the data processing means may be further adapted to set the 2D eye coordinate data as a fixation point when generating the guidance display data; and wherein the data processing means may be further adapted to output the generated guidance display data to the graphical user interface as display data foveated according to the fixation point.

For any of the aforementioned embodiments, the or each parallel processing module may be selected from the group comprising field programmable gate arrays (‘FPGA’), graphical processing units (‘GPU’), video processing units (‘VPU’), application specific integrated circuits (‘ASIC’), image signal processors (‘ISP’), digital signal processors (‘DSP’). Alternatively, or complementarily, the data processing means may be may be selected from the group comprising hybrid programmable parallel-central processing units and configurable processors.

In another aspect, the present invention provides a system, an image-based guidance system, comprising at least one detectable target, one or more portions of which is configured with an optical contrasting agent; and a head mounted display (HMD) device substantially as described hereinbefore, wherein the first pixel data is representative of the one or more portions of the detectable target, and wherein the data processing means is generating three-dimensional (3D) coordinate data representative of the one or more portions of the detectable target, and wherein the one or more further geometrical datasets, each representative of a respective detectable target in the scene.

In embodiments of the system, the optical contrasting agent may be an active agent emitting a light wave, for example a light emitting diode (LED). Alternatively, the optical contrasting agent may be a passive agent, for instance a fluorophore compound, wherein embodiments of the system may further comprise a source of illumination configured to excite the optical contrasting agent in use. In variants of such embodiments, the HMD device may comprise the source of illumination, in order both to coincide the excited agent with the field of view of the HMD device's imaging sensors and minimise the number of hardware units of the system.

In embodiments of the system, each of the one or more portions of the detectable target may be a marker having a predetermined, relative geometric relationship therewith. The or each detectable target may for instance be a tool in use by or proximate the HMD wearer, for example a needle, biopsy syringe or other surgical device, whether handled by the HMD wearer or by another user or a robotic device adjacent the HMD wearer, and at least one amongst the one or more further geometrical datasets comprises a three-dimensional model representative of the tool.

Alternatively, or additionally, the or each detectable target may for instance be a marker defining a location in the scene, for example a fiducial marker indicating a target destination for the surgical device on a patient's body, and at least one amongst the one or more further geometrical datasets may comprise a three-dimensional model representative of the marker. An embodiment of such a marker may be a matrix barcode, also known as a quick response (‘QR’) code or ArUco marker, one or more of portions of which is configured with a passive or active optical contrasting agent, or a combination of both passive and active optical contrasting agents. Another embodiment of a marker defining a location in the scene may be biological tissue rendered fluorescent by the optical contrasting agent after injection or ingestion, having a predetermined, relative geometric relationship with one or more characteristics of the surrounding tissue, for example a distance of the fluorescent tissue relative to a surface of the tissue.

In variants of such embodiments particularly adapted to a scene comprising at least two detectable target, the data processing means of the HMD may be further programmed to generate display data representative of a pathway between the two detectable targets in the scene when generating the 3D guidance display data.

In a further aspect, the present invention provides a method of guiding a detectable target with a head mounted display (HMD) device, comprising the steps of generating pixel data of a scene with imaging sensors of the HMD device, wherein the detectable target is in the scene; with at least one parallel processing module of the HMD device, wherein the module is configured with a plurality of pixel-respective data processing threads, filtering pixel data with a predetermined value to segregate first pixel data from second pixel data, wherein the first pixel data is representative of one or more portions of the detectable target configured with an optical contrasting agent, and computing two-dimensional (2D) pixel coordinate data from segregated first pixel data; with at least one further processing unit of the HMD device, transforming 2D pixel coordinate data by reference to a first geometrical dataset representative of at least one coordinate system originating at the HMD device into three-dimensional (3D) coordinate data representative of the one or more portions of the detectable target, generating 3D guidance display data according to the 3D coordinate data, by reference to one or more further geometrical datasets, each representative of a respective detectable target in the scene, and outputting the 3D guidance display data to a graphical user interface on at least one display of the HMD device.

Other aspects of the invention are set out in the accompanying claims.

### BRIEF DESCRIPTION OF DRAWINGS

The invention will be more clearly understood from the following description of an embodiment thereof, given by way of example only, with reference to the accompanying drawings, in which: —

FIG. 1 provides a front view of an embodiment of a head mounted display (HMD) device according to the invention, including imaging sensors.

FIG. 2 provides a front view of an alterative embodiment of an HMD device according to the invention, configuring the HMD device of FIG. 1 with a source of illumination.

FIG. 3 shows an example hardware architecture of the HMD shown in FIG. 1, including the imaging sensors, data processing means and a memory.

FIG. 4 shows an example hardware architecture of the HMD shown in FIG. 2.

FIG. 5 illustrates an embodiment of a detectable target observable by the imaging sensors of FIGS. 1 to 4.

FIG. 6 illustrates further embodiments of detectable targets observable by the imaging sensors of FIGS. 1 to 4.

FIG. 7 details data processing steps performed by an HMD device of FIGS. 1 to 4 for generating 3D guidance data about a target of FIGS. 5 and/or 6, including steps of filtering pixel data and transforming 2D coordinate data.

FIG. 8 illustrates the contents of the memory of FIG. 3 or 4 at runtime when performing the steps of FIG. 7.

FIG. 9 illustrates the data processing and associated data type flows of FIGS. 7 and 8.

FIG. 10 further details the step of filtering pixel data in FIGS. 7 and 9, performed by the parallel processing unit of FIGS. 3 and 4.

FIG. 11 further details the step of generating 3D guidance data in FIGS. 7 and 9, performed by the further processing unit of FIGS. 3 and 4.

FIG. 12 further details an alternative embodiment of the step of filtering pixel data in FIGS. 7 and 10.

FIG. 13 provides a front view of an alternative embodiment of an HMD device comprising a time of flight sensor.

### DETAILED DESCRIPTION OF DRAWINGS

There will now be described by way of example specific modes contemplated by the inventor. In the following description and accompanying figures, numerous specific details are set forth in order to provide a thorough understanding, wherein like reference numerals designate like features. It will be readily apparent to one skilled in the art, that the present invention may be practiced without limitation to these specific details. In other instances, well known methods and structures have not been described in detail, to avoid obscuring the description unnecessarily.

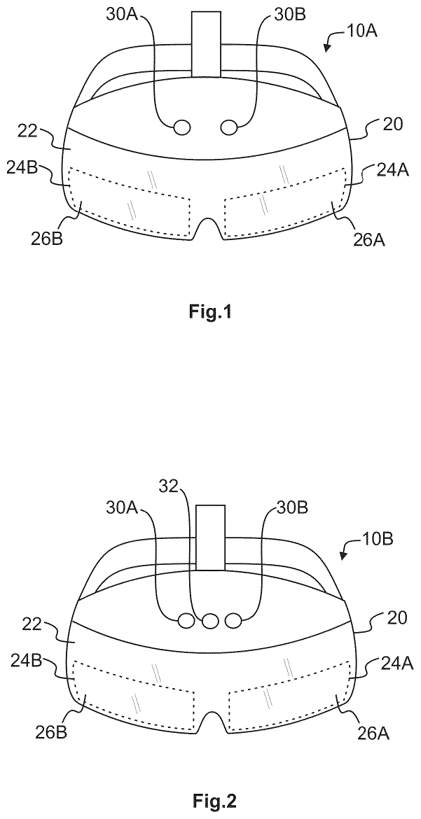

With reference to FIG. 1, a first embodiment 10A of a HMD device comprising imaging means and display means according to the invention is shown, in the example an augmented reality (‘AR’) device. The AR HMD 10A comprises a wearer visor 20, which includes a main see-though portion 22 and eye-respective video display portions 24A, 24B located equidistantly of a central bridge portion overlying a wearer's nose in use. The display portions 24A, 24B implement, perceptually, a single video display occupying a subset of the front aspect of the HMD, wherein the wearer can observe both the ambient physical environment in front of the HMD 10 and video content superimposed thereon.

Each video display portion 24A, 24B consists of a respective video display unit 26A, 26B, in the example a micro OLED panel with a minimum 60 Hz frame refresh rate and a resolution of 1920×1080 pixels, located proximate a lower edge of the visor so as to leave the see-though portion 22 extending above it and up to its upper edge, clear of visual occlusion when the VDUs are displaying. The HMD further comprises first and second high resolution imaging sensors 30A, 30B disposed in a stereoscopic arrangement, each of which captures visible light in a wavelength range of typically 400 to 700 nm in its field of view (FoV) of typically 70 to 160 degrees or even more, and outputs captured image as a stream of pixel data, at a resolution of 1920×1080 pixels at least, and at a rate of 60 frames per second or more.

With reference to FIG. 2, wherein like numerals designate like features relative to FIG. 1, a second embodiment 10B of a head mounted display (‘HMD’) device comprising imaging means and display means according to the invention is shown, which additionally comprises a source of illumination 32, for example a light emitting diode (‘LED’) 32 emitting light in the wavelength range 800 to 2,500 nm corresponding to near infrared (‘NIR’) light, for exciting aspect(s) of a target or subject configured with a passive optical contrasting agent, e.g. a fluorophore, in the respective FoVs of the HMD imaging sensors 30A-B.

Skilled person will also appreciate that the technical principles disclosed herein may implemented in other HMD types, such as an augmented reality monocular or contact lens device, virtual reality (‘VR’) or mixed reality (‘MR’) closed display device, wherein the eye-respective video display portions 24A, 24B implement, perceptually, a single video display portion occupying substantially the whole inner front aspect of the HMD. For such HMDs, each video display portion 24A, 24B may consist of a RGB low persistence panel with a minimum 60 Hz frame refresh rate and an individual resolution of 2048×1080 pixels per eye, for a perceived single video display with a resolution of 4096×2160 pixels.

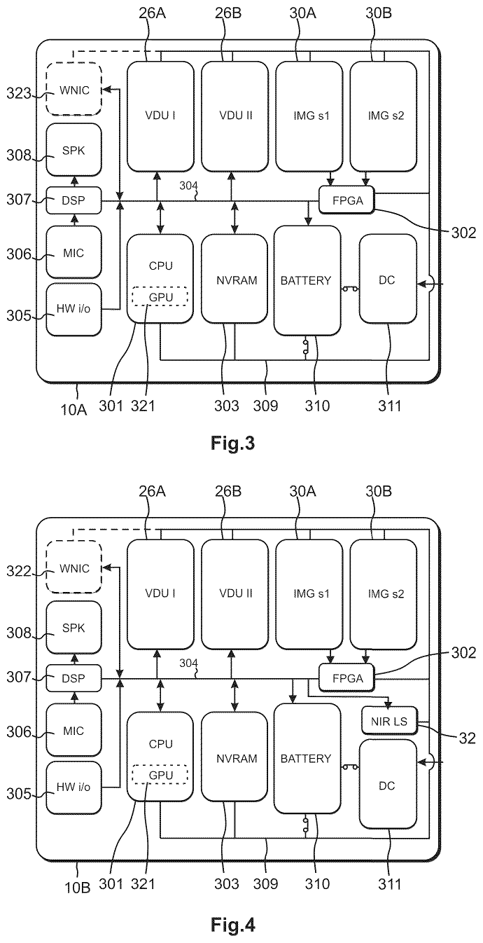

Embodiments of the HMD according to the invention may include fewer or further imaging sensors, by way of imaging means. The technique of the invention can be practiced with a single imaging sensor 30A and a target of known geometry, which contains at least 4 detectable points, or with the 2 imaging sensors 30A-B as described above with at least 3 detectable points. Embodiments of the HMD according to the invention may also, or instead, include other types of sensors, for example a distance or depth sensor implementing a time-of-flight technique or the like, particularly useful to prevent display artefacts according to principles described hereinafter. Example hardware architectures for HMD devices 10A-B according to the invention are next described in further detail with reference to, respectively, FIGS. 3 and 4, wherein like numerals reference like features, by way of non-limitative examples.

All embodiments of a HMD according to the invention comprise data processing means. Accordingly, in addition to video display units 26A-26B and imaging sensors 30A-B, and optionally a NIR LED 32, a HMD according to the invention includes data processing means, consisting of at least one data processing unit 301, acting as the main controller of the HMD, and at least one parallel processing module 302 pre-processing pixel data generated by the imaging sensors 30A-B. The CPU 301 is for instance a general-purpose microprocessor according to the Cortex™ architecture manufactured by ARM™, and the parallel processing module 302 is for instance a field programmable gate array (‘FPGA’) semiconductor device according to the Artix™ architecture manufactured by AMD™ Xylinx™.

The CPU 301 may further include or be associated with a dedicated graphical processing unit (‘GPU’) 321 receiving data and processing commands from the CPU 301 for generating display data before same is output to the displays 26A-26B. The CPU 301 and the FPGA 302 are coupled with memory means 303, comprising volatile random-access memory (RAM), non-volatile random-access memory (NVRAM) or a combination thereof by a data input/output bus 304, over which they communicate and to which the other components of the HMD 10A-B are similarly connected, in order to provide headset functionality and receive user commands.

The data connection between the imaging sensors 30A-B, the CPU 301 and the FPGA 302 via the bus 304 or another, is a high-frequency data communication interface and at least the FPGA 302 (but preferably also the CPU 301) is located closest to the imaging sensors 30A-B interconnects, i.e. within the front aspect or portion of the HMD device, in order to minimise latency of data flows.

User input data may be received directly from a physical input interface 305, which may be one or more buttons, including at least an on/off switch, and/or a portion of the HMD casing configured for haptic interaction with a wearer's touch. User input data may also be received indirectly, such as gestures captured optically by the optical sensors 30A-B and/or spoken words captured as analogue sound wave data by a microphone 306, for which a DSP module 307 implements an analogue-to-digital converting function, which the CPU 301 then interprets according to principles outside the scope of the present disclosure. Processed audio data is output to a speaker unit 308, and power is supplied to all the components by an electrical circuit 309, which is interfaced with an internal battery module 310, wherein the battery is periodically recharged by an electrical converter 311.

HMD embodiments may further include a data connectivity capacity, shown in dotted line as a wireless network interface card or module (WNIC) 322, also connected to the data input/output bus 304 and the electrical circuit 308, and apt to interface the HMD with a wireless local area network (‘WLAN’) generated by a local wireless router. Alternative or additional wireless data communication functionality may be provided by the same or another module, for example implementing a short-range data communication according to the Bluetooth™ and/or Near Field Communication (NFC) interoperability and data communication protocol.

HMD devices of the invention are used to guide items relative to others and/or to item destinations in scenes, for example to guide a surgical device during a surgical procedure. Items and item destinations thus need to be detectable targets, and embodiments of the invention rely upon configuring such targets with a passive or active optical contrasting agent, to be captured as imaging data by the imaging sensors 30A-B in use.

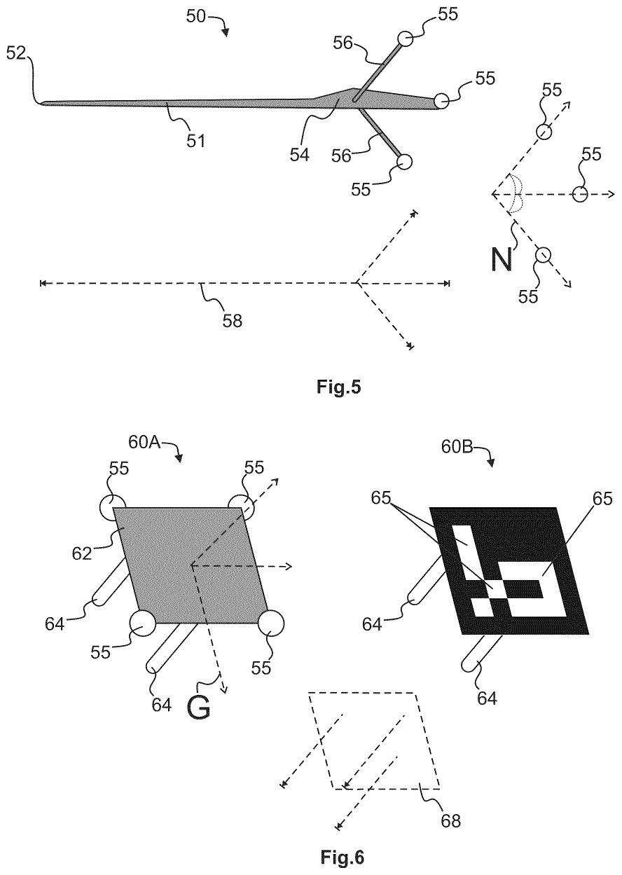

With reference to FIG. 5, a first embodiment of a detectable target is shown, in the example a surgical tool 50 having an elongate body 51 terminated by a needle 52 at a first end for facilitating a subcutaneous insertion, and a user grip portion 54 distal the needle and proximate the second, opposed end of the tool, which is terminated by a geometrical reference dot or indicator 55 coated with a passive contrasting agent. Skilled persons will appreciate that the passive geometrical indicator 55 may be substituted for an active indicator, e.g. a LED, equally compatible with the techniques described herein.

The three-dimensional pose of any target detectable in the scene facing the HMD 10A-B needs to be determined, accordingly the example surgical tool 50 comprises at least two further geometrical reference indicators 55, each attached to the grip portion 54 by a stalk-like member 56, each stalk member oriented orthogonally to the other and to the main axis of the elongate body 51. Suitably, the three geometrical reference indicators 55 collectively define a three-dimensional coordinate system N originating at the target 50, an axis of which is coaxial with the tool's main axis. A longitudinal dimension of the surgical tool 50 between its opposed ends 52, 55 is known, likewise the respective dimension between each further geometrical reference indicator 55 and the grip portion surface, whereby the three-dimensional geometry 58 of the tool is known and accordingly preset.

With reference to FIG. 6, two further embodiments of a detectable target are shown, that may be used as fiducial markers to indicate an item destination in a scene. In a first example, a surgical marker 60A has a planar body 62 shaped as a square, from an underside of which a plurality of locating feet members 64 extend, wherein each foot member may optionally be terminated by a needle distal the body 62 for facilitating a subcutaneous insertion, or by a clamp, grip or some other means of attachment to a patient. A geometrical reference indicator 55 as previously described is secured to each corner of the planar body 62, wherein the four geometric reference indicators 55 corresponding with, and thus define, the main plane of the marker 60A and its orientation at any given time. Suitably, any three of the four geometrical reference indicators 55 collectively define a three-dimensional coordinate system G originating at the geometric center of the main plane of the target 60A, two orthogonal axes of which are co-planar with the fiducial marker's main plane and the third axis of which is orthogonal thereto.

In a second example, another surgical marker 60B has substantially the same configuration as before, for the sake of simplicity of description. However, rather than securing physical indicators 55 to some or each corner of its planar body 62, in this embodiment the topside of the main plane of the body is configured as a matrix barcode patterned according to the ArUco™ technique, having several geometric portions 65 that are each coated with a passive optical contrasting agent. White portions are coated in the ArUco™ marker 60B of the example, but the skilled person will easily appreciate that the black portions may be coated with the passive optical contrasting agent instead, likewise that the passive optical contrasting agent may be substituted for one or more active indicators such as LEDs. ArUco™ markers are known to encode more geometric and semantic information relative to classic matrix (QR) barcodes and dot-like passive or active indicators 55, wherein this enhanced accuracy can be leveraged by the technique of the invention with the addition of optical contrasting properties.

Accordingly, in this example again, the geometric reference indicator 65 constituted by the optically contrasting pattern defines at least the main plane of the marker 60B and its orientation at any given time, and may encode still further information, for instance dimensional data of the marker. Suitably, the geometrical reference indicator 65 of this example defines the same three-dimensional coordinate system G originating at the geometric center of the main plane of the target 60B, two orthogonal axes of which are co-planar with the marker's main plane and the third axis of which is orthogonal thereto.

A lateral dimension of the surgical marker 60A, 60B between two corners of its main plane is known, likewise the respective location and dimension of each foot member 64 extending underneath the main plane, and/or may be encoded in the detectable pattern 65 thereon and decoded by a relevant configuration of the HMD, whereby the three-dimensional geometry 68 of the marker is known and accordingly preset.

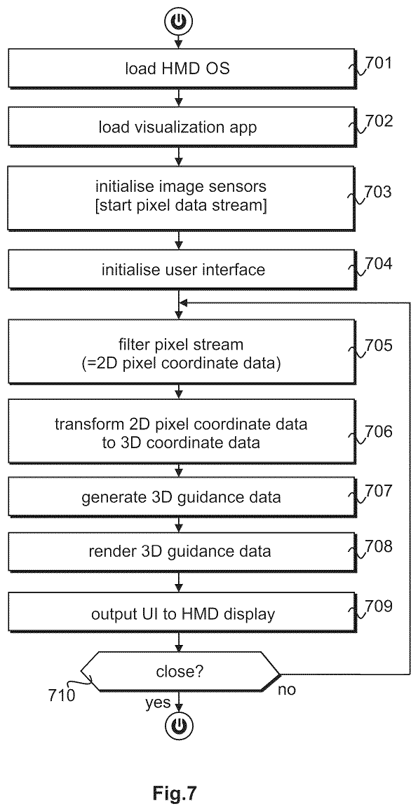

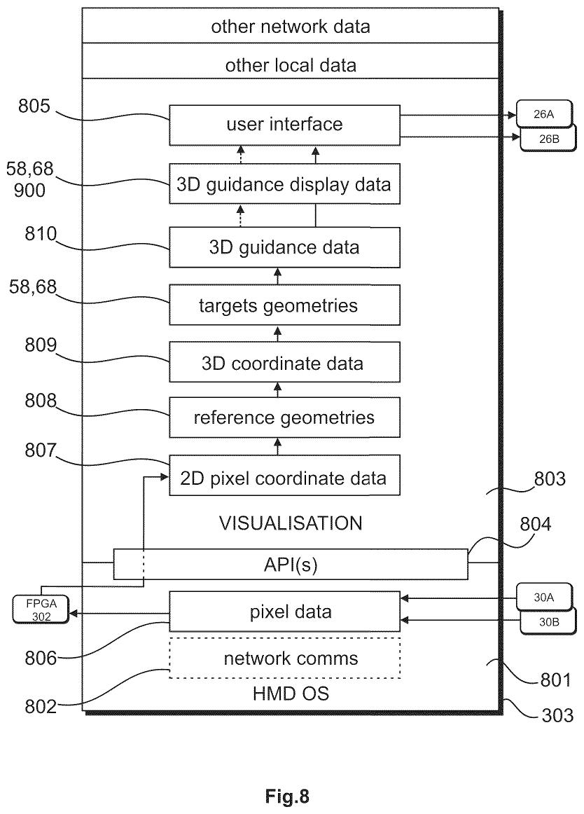

Basic and enhanced data processing configuration and functionality of a HMD 10A-B of FIGS. 1 to 4 is now described according to an embodiment of the invention, by reference to FIGS. 7 to 11, wherein data structures stored in the memory 303 and processed by the FPGA 302 and the CPU 301 are shown in FIG. 8, like numerals referencing like features, steps and structures throughout.

An operating system 801 is initially loaded at step 701 when first powering the HMD 10A-B, for governing basic data processing, interdependence and interoperability of HMD components 26A-B, 30A-B, 32 when present, and 301 to 321, moreover including the WNIC 322 when present. The HMD OS may be based on Android™ distributed by Google™ of Mountain View, California, United States. The OS includes device drivers for the HMD components, input subroutines for reading and processing input data, including user direct input to the physical interface device 305, and output subroutines for outputting display data to the displays 26A-B. Notably, the OS 801 interfaces an output of the imaging sensors 30A-B with the FPGA 302 within a low computational layer, at kernel level in the example, for minimal latency. In embodiments of the HMD 10A-B including networking means 322, the OS 601 further includes communication subroutines 802 to configure the HMD 10A-B for bilateral network communication with remote terminals via the WNIC 322 interfacing with a network router device.

At step 702, a set of instructions embodying a visualization application 803 is loaded, either as a subroutine of the OS 801 or as a distinct application in a higher computational layer. The visualization application 803 is interfaced with the FPGA 302 through the OS 801 via one or more Application Programming Interfaces (API) 804. The visualization application 803 comprises and coordinates data processing subroutines embodying the various functions described herein, including the updating and outputting of a user interface 805 to the displays 26A, 26B in real-time.

Further to initialising the imaging sensors 30A-B at step 703 for generating respective pixel data streams 806, at times inclusive of one or more target 50, 60A-B and respective geometrical reference indicators 55, 65 thereof, the user interface 805 is itself initialised at step 704, whereby the HMD 10A-B is configured to start processing image data for display navigation in real time.

At step 705, the FPGA 302 receives the pixel data streams 806 and filters each input pixel according to a predetermined value, for example a pixel brightness or luminance threshold value corresponding to a captured optical contrasting agent of a geometrical reference indicator 55 in an excited state, or a pixel location offset relative to a location in a previous capture.

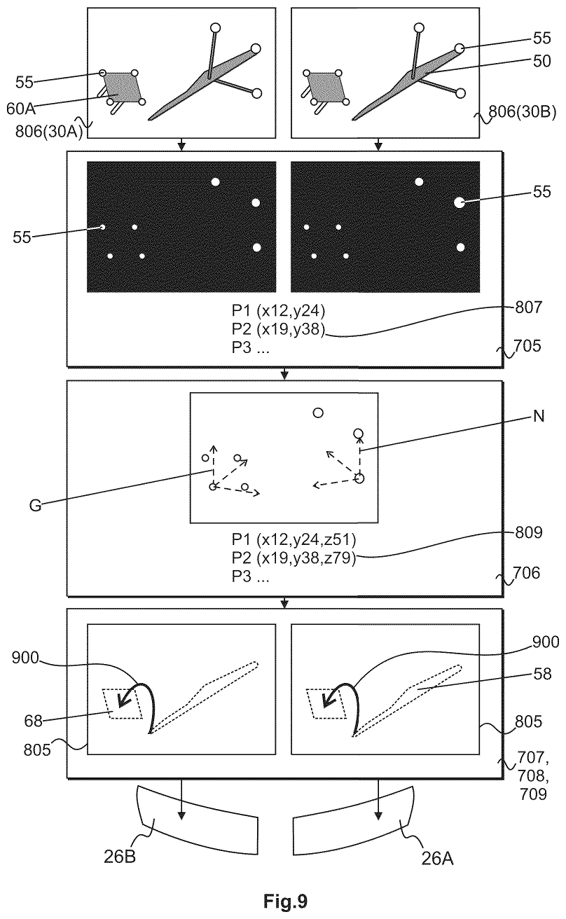

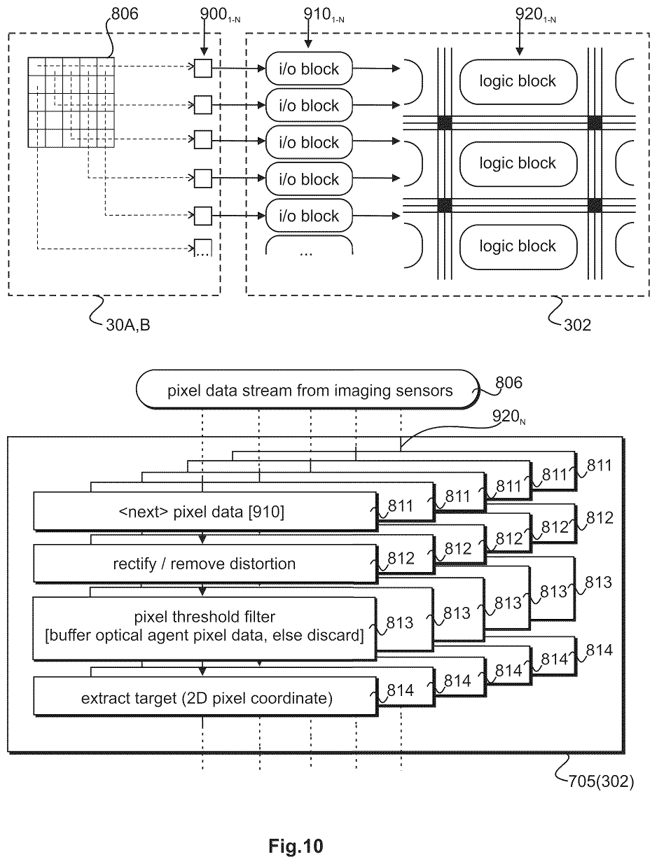

With reference to FIG. 10 specifically, each pixel 900_{N} in a pixel data stream 806 is input to a respective input block 910_{N} of a respective data processing thread, or pipeline, 920_{N} implemented within the massively-parallel architecture of the FPGA 302. Each parallel pipeline 920_{1-N} is configured to receive pixel-respective data at step 811, to perform one or more standard artefact-removing operations at step 812, for example rectification and lens-related distortion removal, in order to obtain corrected, accurate pixel data, then to segregate the accurate pixel data according to the predetermined value at step 813, between pixel data matching or exceeding that predetermined value, which therefore corresponds to a geometrical reference indicator 55 in the pixel data stream, and pixel data below that predetermined value, corresponding to any other aspect of the captured scene, of no further interest and accordingly discarded. As illustrated in FIG. 9, the output of step 803 is very low entropy, binary image data, encoding only data representative of each geometrical reference indicator 55 in the field of view of the imaging sensors 30A-B and its respective and corrected two-dimensional (2D) screen coordinates in the frame, which are computed for extraction at step 814.

The output of the FPGA 302 at step 705, shown at 807, is accordingly low entropy data describing each pixel representative of a geometrical reference indicator 55 and its corrected 2D position within the field of view of the imaging sensors 30A-B at that precise moment in time, data which is significantly less voluminous than full- or even low-resolution RGB or greyscale image data as typically used in known image-based navigation systems.

At step 706, the CPU 301 receives the 2D pixel coordinate data 807 from the FPGA 302 and transforms same into three-dimensional (3D) pixel coordinate data 809. This transformation may be implemented with a variety of techniques, by way of non-limitative transformation may be implemented with various techniques, for example subject to whether the HMD 10 comprises a single imaging sensor 30A or a pair of imaging sensors 30A-B in a stereoscopic arrangement.

In the case of a stereoscopic HMD 10A,B, the transformation can be implemented through a triangulation technique, wherein the CPU 301 triangulates the 2D pixel coordinate data 807 from the FPGA 302 by reference to a first geometrical dataset 808 representative of at least one coordinate system originating at the HMD 10A-B, thereby generating the 3D coordinate data 809 representative of the or each target 50, 60A-B relative to the HMD 10A-B. Herein, the verb ‘triangulate’ and equivalent adjectives and expressions shall be understood under their ordinary meaning in the field of computer vision, namely as the process of determining a point in 3D space given its projection onto a 2D image plane. Accordingly the skilled person shall understand that different techniques may be used to implement this particular process, for example a direct linear transformation or, subject to the quality and accuracy of the 2D dataset 807 in HMD embodiments with high resolution and high framerate imaging sensors, more computationally efficient alternatives.

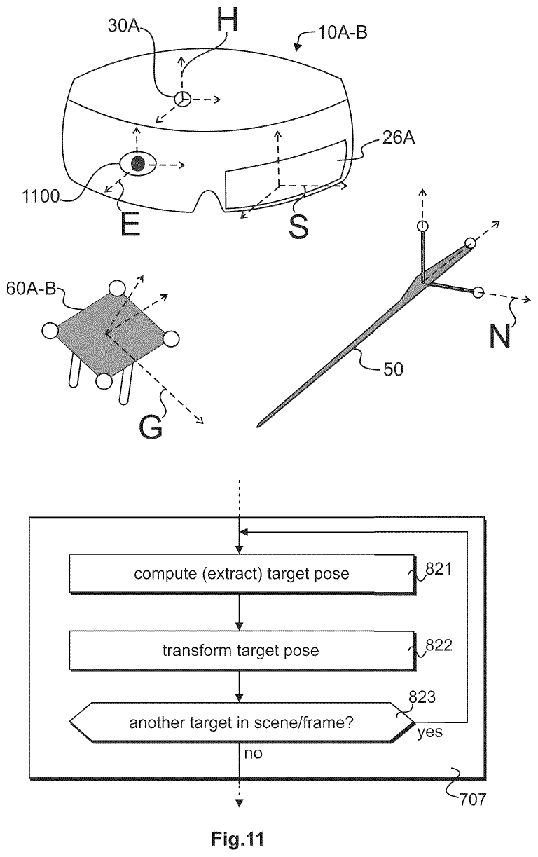

With reference to FIG. 11 specifically, characteristics of the HMD10A-B and intrinsic parameters of its components relevant to the optical and vision system embodied therein are known from manufacturing and preset. The reference geometrical dataset 808 accordingly comprises one or more coordinate systems, each originating at a respective component of the HMD, that are pre-calibrated, as are the 6 DoF transformations therebetween, represented by a 3×3 rotation matrix R and a 3×1 translation vector t. In the example, a three-dimensional coordinate system H originates at the imaging sensor 30A, a three-dimensional coordinate system S originates at the display 26A and a three-dimensional coordinate system E originates at the HMD wearer's right or left eye 1100, are included into the first geometrical dataset 808.

Accordingly, when the triangulation of step 706 is performed at step 821 by reference to the first geometrical dataset 808, the 6 DoF transformations are known between H and E, i.e.

$$( {R}_{E}^{H} , {t}_{E}^{H} )$$

and between E and S, i.e.

$$( {R}_{E}^{S} , {t}_{E}^{S} )$$

and are accordingly pre-computed. Similarly, the transformation between left and right imaging sensors 30A-B, thus the baseline distance b therebetween, is also known. The assumption that the respective intrinsic parameters of the pair of imaging sensors 30A-B are identical is defined as:

$$K = ( \begin{matrix}{f}_{x} & 0 & {c}_{x} \\ 0 & {f}_{y} & {c}_{y} \\ 0 & 0 & 1\end{matrix} )$$

wherein fₓ, f_{y} correspond to the imaging sensors' focal lengths in the x and y dimensions and cₓ, c_{y} correspond to the imaging sensors' centre of projections likewise in the x and y dimensions, respectively.

Given the stereo image data Iₗ, Iᵣ captured by the pair of imaging sensors 30A-B respectively, a set of n∈ [symbol] geometrical indicators 55 in the scene are detected and their corresponding 2D positions

$$\{ {p}_{1}^{l} , … , {p}_{n}^{l} \}$$

$$and$$

$$\{ {p}_{1}^{r} , … , {p}_{n}^{r} \}$$

807 are extracted at step 705 and
received as an input at step 706. The 3D position

$${P}_{i}^{H} = ( {X}_{i}^{H} , {Y}_{i}^{H} , {Z}_{i}^{H} )$$

position

$${p}_{i}^{l} = ( {x}_{i}^{l} , {y}_{i}^{l} )$$

$$and$$

$${p}_{i}^{r} = ( {x}_{i}^{r} , {y}_{i}^{r} )$$

of each pixel corresponding to a geometrical indicator 55, wherein 0<i<n, is given by:

$${Z}_{i}^{H} = \frac{{f}_{x} \cdot b}{{x}_{i}^{l} - {x}_{i}^{r}} ,$$

$${X}_{i}^{H} = \frac{{Z}_{i}^{H} \cdot ( {x}_{i}^{l} - {c}_{x} )}{{f}_{x}} ,$$

$${Y}_{i}^{H} = \frac{{Z}_{i}^{H} \cdot ( {y}_{i}^{l} - {c}_{x} )}{{f}_{y}} .$$

The 3D positions are then transformed from H to E, via

$${P}_{i}^{E} = {R}_{E}^{H} {P}_{i}^{H} + {t}_{E}^{H} .$$

$${P}_{i}^{E} = ( {X}_{i}^{E} , {Y}_{i}^{E} , {Z}_{i}^{E} )$$

is then correctly projected onto S, taking into account the current eye position with respect to S, i.e.

$${t}_{E}^{S} = ( {x}_{E}^{S} , {y}_{E}^{S} , {z}_{E}^{S} ) .$$

This is done by modelling the eye 1100 and the HMD displays 30A-B as an off-axis pinhole imaging sensor with the intrinsic matrix KE, defined as:

$${K}_{E} = \begin{matrix}{a}_{x} & 0 & 0 & {z}_{E}^{S} & 0 & - {x}_{E}^{S} \\ ( 0 & {a}_{y} & 0 ) & ( 0 & {z}_{E}^{S} & - {y}_{E}^{S} ) , \\ 0 & 0 & 1 & 0 & 0 & 1\end{matrix}$$

wherein aₓ, a_{y} are the scaling factors which convert 3D points on the screen to pixel points.

Accordingly, the rendering position of

$${P}_{i}^{E}$$

on S, as three-dimensional (3D) coordinate data 809, is determined as:

$${p}_{i}^{S} = ( {a}_{x} ( \frac{{X}_{i}^{E}}{{Z}_{i}^{E}} {z}_{E}^{S} - {x}_{E}^{S} ) , {a}_{y} ( \frac{{Y}_{i}^{E}}{{Z}_{i}^{E}} {z}_{E}^{S} - {y}_{E}^{S} ) ) .$$

Assumptions in the above are that the transformation between camera and eye

$$( {R}_{E}^{H} , {t}_{E}^{H} )$$

and between display and eye

$$( {R}_{E}^{S} , {t}_{E}^{S} )$$

are known and precomputed. In certain embodiments, these transformations may be computed with an additional eye tracker (e.g. F), wherein precomputed or precalibrated transformations include between camera and tracker

$$( {R}_{F}^{H} , {t}_{F}^{H} )$$

and between camera and display

$$( {R}_{S}^{H} , {t}_{S}^{H} ) .$$

At runtime the tracker estimates the position of the eye and outputs eye coordinate data, which is used to compute and update the transformation between tracker and eye

$$( {R}_{E}^{F} , {t}_{E}^{F} ) ,$$

wherein

$$( {R}_{E}^{S} , {t}_{E}^{S} )$$

is computed via

$$( {R}_{F}^{H} , {t}_{F}^{H} ) ,$$

$$( {R}_{S}^{H} , {t}_{S}^{H} ) and ( {R}_{E}^{F} , {t}_{E}^{F} )$$

and wherein

$$( {R}_{E}^{H} , {t}_{E}^{H} )$$

is computed via

$$( {R}_{F}^{H} , {t}_{F}^{H} ) and ( {R}_{E}^{F} , {t}_{E}^{F} ) .$$

Alternatively, in the case of a HMD with a single imaging sensor 30A, the transformation may be implemented by solving for rotation and translation based on the 2D pixel coordinate data, i.e. with a solver technique, for example based on a pose computation problem such as the Perspective n-point Problem (‘PnP’), which aims to recover the position and orientation of an object, by aligning 2D image data captured therewith to a 3D model that describes the real world.

This technique calculates the pose of the target 50, 60, including a rotation matrix R and a translation vector t, between the world frame, in which the target 50, 60 is situated, and the frame of the imaging sensor 30A, from N feature points, wherein N≥3, corresponding to the 2D pixel coordinate data 807 by way of input. The solution output by the solver is that which minimizes the reprojection error between the target's 3D points and the input 2D point data, corresponding to the 3D coordinate data 809 representative of the or each target 50, 60A-B relative to the HMD 10A-B.

Upon completing the transformation of step 706, the CPU 301 generates 3D guidance data according to the 3D coordinate data 809 at step 707, by reference to one or more further geometrical datasets, each of which is representative of a respective target 50, 60A-B in the scene and examples of which are the preset geometries 58, 68 shown in FIGS. 5 and 6.

Accordingly at step 821, the CPU 301 computes or ‘matches’ the pose of the or each target 50, 60A-B, subject to meeting a quorum of at least three geometrical indicators 55 per detected target. Many techniques are known to implement this step, the purpose of which is to compare the 3D coordinate data 809 of step 821 with the preset geometries 58, 68 of targets detected in the scene for a geometrical match and, upon matching one or more geometries, determining the orientation of the or each matched geometry in 6DoF, or pose, at that precise moment in time. An example technique is Umeyama's least squares estimation technique (IEEE Transactions on Pattern Analysis and Machine Intelligence, Vol. 13, Issue 4, April 1991). The CPU 301 may additionally compute semantic, fiducial or similar other meaningful indicator data both derivable from the geometric information inherent to the extracted poses and capable of display in the user interface 805, for example a guiding line 900 extending between a detected target 50 and a detected marker 60A-B, of a dimension calculated by reference to the known preset geometries 58, 68 and with a 6DoF pose calculated by reference to their respective extracted poses.

At a next step 822, the CPU 301 computes a transformation of the extracted pose for the first matched geometry 58, 68 relative to the origin of the field of view corresponding to the perspective of the user interface 805, i.e. relative to the ‘virtual camera’ by reference to which 3D objects are rendered in the user interface 805. A question is asked next at step 823, about whether the pose of a further matched geometry 58, 68 and/or semantic or fiducial indicator remains to be extracted and transformed, wherein control returns to step 821 in the affirmative. Alternatively, or eventually when the respective pose of each matched geometries 58, 68 and optional semantic or fiducial indicator has been extracted and transformed, the computed transformation accordingly comprises 3D guidance data 810, namely data defining the pose of the or each target 50, 60A-B detected in the field of view of the imaging sensors 30A-B at that precise moment in time, and optionally data defining any additional semantic or fiducial indicator, for rendering to the user interface 805 as promptly as processing latency of the HMD components involved allows.

At a next step 708, the 3D guidance data 810 is submitted to a rendering subroutine of the visualisation application 804, which is processed either by the CPU 301, or by the GPU 321 when present within the HMD architecture, advantageously relieving the CPU 301 from the corresponding graphics processing overhead. 3D guidance display data 820 is generated from the 3D guidance data 810, for instance by mapping respective target geometry dataset(s) 58, 68 to respective target pose data 810 and mapping semantic or fiducial graphical data 900 to semantic or fiducial indicator pose data 810. The rendering subroutine may further transform the 3D guidance data 810 according to any intervening update to the world coordinate space, since the coordinates of at least the imaging sensor 30A, and optionally other anchor(s) such as the eye 1100, can change significantly from a current display frame to the next, in order to maintain relative positions of their respective physical locations.

The rendered 3D guidance display data 820 is suitably output to the user interface 805 at step 709, still as promptly as processing latency of the HMD components involved allows. whereby the HMD wearer is presented with a representation 58 of the surgical tool 50, a representation 68 of the fiducial marker 60A or 60B and a fiducial indicator 900 extending between both representations, on both displays 26A-B, thus in superimposition on the see-through field of view of the visor 20, at accurate respective locations and orientations. A question is asked at step 710, about whether the operation of the HMD should be interrupted, which is answered negatively so long as the HMD remains in use and wherein the logic returns to the pixel segregation of step 705, and so on and so forth until the HMD should be switched off.

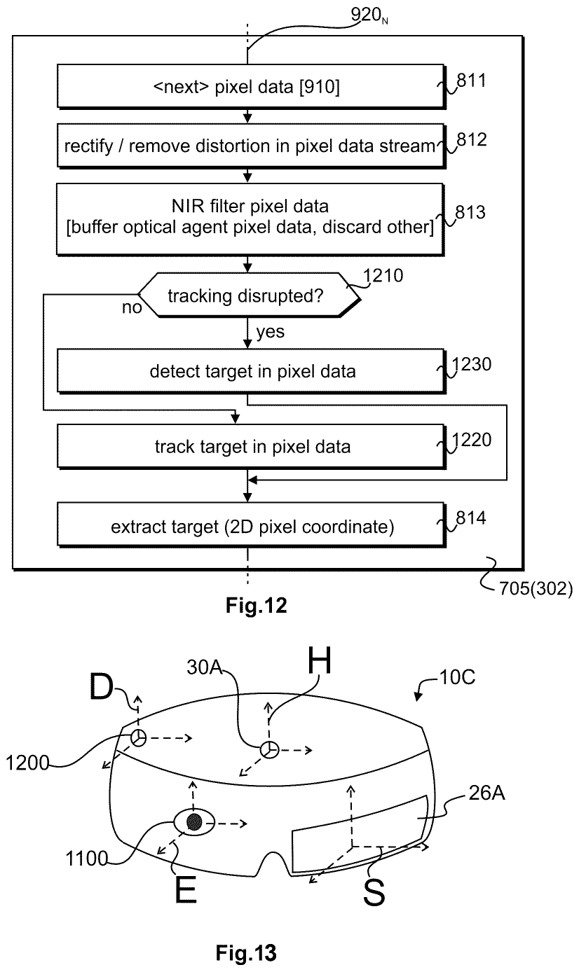

With reference to FIG. 12A, an alternative embodiment of the logic of a parallel processing pipeline 920 of the FPGA 302 may be modified to query 1210, after the segregation of step 803, whether the tracking of a target 50, 60A-B, in the scene has been disrupted. For example, this query may be embodied with a simple buffer of the segregation status for a set pixel, i.e. wherein the segregation status of the same pixel is compared between the previous frame and the current frame, and wherein a change of status for the pixel segregation between two consecutive indicates a tracking disruption.

When the question of step 1210 is answered negatively, the logic maintain the target tracking within the pixel data stream 806 at step 1220. Alternatively, when the question of step 1210 is answered positively, the logic reacquires the target within the pixel data stream 806 at step 1230. In either case, the logic then proceeds to the 2D coordinate data extraction of step 804.

With reference to FIG. 12B, an alternative embodiment of the HMD device 10C may be configured with a single imaging sensor 30A and a time-of-flight (ToF) sensor 1200, which facilitates the detection and tracking of detectable targets 50, 60A-B by determining their respective distance to the HMD device 10C. The single imaging sensor 30A supplies the FPGA 302 with the pixel stream 806 for low entropy filtration according to step 705 as previously described. In this embodiment, characteristics of the HMD10C and intrinsic parameters of its components are still known from manufacturing and preset, wherein the reference geometrical dataset 808 accordingly comprises a further coordinate system D originating at the ToF Sensor 1200. As the triangulation of step 706 is again performed at step 706 by reference to the first geometrical dataset 808, the 6 DoF transformations are known between H and D i.e.,

$${T}_{D}^{H} ,$$

between D and E i.e.,

$${T}_{E}^{D}$$

and between E and S i.e.,

$${T}_{E}^{S}$$

and wherein
the 3D positions are now accordingly transformed from H to E via

$${P}_{i}^{E} = {T}_{E}^{D} {T}_{D}^{H} {P}_{i}^{H}$$

instead. The target-respective distance data supplied by the ToF sensor 1200 is used by the CPU 301 to estimate the position of each detected target relative to the HMD and the generating of 3D guidance data at step 707 is facilitated with this positional data. The ToF sensor 1200 accordingly maintains the accuracy of the technique disclosed herein with a single imaging sensor, advantageously reducing the overall volume of image data processed by the HMD architecture still further.

The CPU 301 of the HMD 10C may be further adapted to determine a mismatch between the generated 3D guidance display data 820 and the HMD wearer eye 1100 based on a distance measurement and a position of the wearer's eye, and adjust a position of the generated 3D guidance display data 820 in the graphical user interface 805 according to the determined mismatch, as taught by Applicant in GB 2588774 A. For example, the distance measurement may be performed based on stereoscopic image data captured by the image sensors 30A-B of stereoscopic HMDs 10A,B, and/or may be performed or augmented by the ToF sensor 1200 of the HMD 10C.

Still further embodiments of the hardware-accelerated pixel data segregation technique disclosed herein for AR navigational purposes are contemplated. Imaging sensors 30A-B may be capable of configuration to perform optical filtering of the scene and, with reference to the active or passive optical contrasting agent applied to targets 50, 60A-B, to filter geometrical indicators 55 at the time of capture, supplying the parallel processing module 302 with already-segregated data on which to perform steps 812 and 814, thereby accelerating the technique significantly. The filtering of step 803, when based on a thresholding approach, may be implemented with different value-based comparators. In a first alternative, the brightness or luminance values in pixel data 806 may be rounded or truncated, by reference to a threshold value or range. In a second alternative, pixel data 806 may be selected in each pipeline 920 by reference to a threshold value or range stored in the parallel module 302 or the memory 303.

For any of these alternatives, and the main embodiment described herein, the segregation may be further accelerated by spatial selectivity, wherein only a subset of the pixel data 806, defined by reference to the resolution of the imaging sensors 30A-B, for example a range or diameter having the centre pixel as its origin and expressed as a pixel count, or some other predetermined position in the captured image data, is input to the parallel pipelines 920.

Surgical tools and markers are known, which comprise an active or passive magnetic transponder unit or module, to aid in determining their position within an operating theater. When configuring such devices with an optical contrasting agent, the triangulation of 2D pixel coordinate data at step 706 and the generating of 3D guidance data at step 707 can be facilitated by using target-respective positional data acquired from a magnetic sensor of the HMD or of an external device or system in wireless data communication therewith through the WNIC 322, substantially in the same manner as when using target-respective positional data determined from distances measured by the time-of-flight sensor 1200 of the HMD 10C.

Skilled persons will understand that the hardware-accelerated pixel data segregation technique disclosed herein for AR navigational purposes has been described by reference to a surgical field of application by way of non-limitative example, and is capable of adaptation to many other fields of application, wherein accurate low-latency visual guidance is desirable with maximum portability and least encumbrance to the HMD wearer. Moreover, skilled persons will likewise understand that the pixel data segregation technique disclosed herein may be adapted to other types of HMDs, for example video see-through virtual reality (VR) and particularly mixed-reality (MR) HMDs, since the imaging sensors, coincidental fields of views and line-of-sight visualizations are substantially similar including, for MR HMDs, a capacity to image the field of view in front thereof as a substitute for a clear visor 20.

In the specification the terms “comprise, comprises, comprised and comprising” or any variation thereof and the terms include, includes, included and including” or any variation thereof are considered to be totally interchangeable and they should all be afforded the widest possible interpretation and vice versa. The invention is not limited to the embodiments hereinbefore described but may be varied in both construction and detail.

1. A head mounted display (HMD) device comprising
imaging means generating pixel data representative of a scene in use;
display means outputting a graphical user interface in use;
power means, data storage means storing geometrical datasets and data processing means operably interfaced with the imaging means and the display means, wherein the data processing means comprises—
at least one parallel processing module configured with a plurality of pixel-respective data processing threads, adapted to—
filter pixel data with a predetermined value to segregate first pixel data from second pixel data, wherein the first pixel data is representative of an optical contrasting agent applied to at least one target in the scene, and
compute two-dimensional (2D) pixel coordinate data from segregated first pixel data; and
wherein the data processing means is further adapted to—
transform the computed 2D pixel coordinate data by reference to a first geometrical dataset representative of at least one coordinate system originating at the device, into three-dimensional (3D) coordinate data representative of the or each target relative to the device,
generate 3D guidance data according to the 3D coordinate data, by reference to one or more further geometrical datasets, each representative of a respective target in the scene, and
output the 3D guidance data to the graphical user interface.

2. The head-mounted display device according to claim 1, wherein the data processing means is further adapted to transform the computed 2D pixel coordinate data by triangulating the 2D pixel coordinate data by reference to the first geometrical dataset.

3. The head-mounted display device according to claim 1, wherein an origin of the at least one coordinate system originating at the device is selected from an aperture of the imaging means, a display unit of the display means and one of the HMD wearer's eyes.

4. The head-mounted display device according to claim 3, wherein the first geometrical dataset comprises a calibrated set of transformations between coordinate systems originating respectively at the aperture of the imaging means, the display unit and the HMD wearer's eye.

5. The head-mounted display device according to claim 1, wherein the data processing means is further adapted to transform the computed 2D pixel coordinate data by solving for rotation and translation based on the 2D pixel coordinate data.

6. The head-mounted display device according to claim 1,
wherein at least one target in the scene is a tool in use by or proximate the HMD wearer, and at least one amongst the one or more further geometrical datasets comprises a three-dimensional model representative of the tool; and/or
wherein at least one target in the scene is a marker defining a location in the scene, and at least one amongst the one or more further geometrical datasets comprises a three-dimensional model representative of the marker.

7. The head-mounted display device according to claim 6, wherein the scene comprises at least two targets and wherein the data processing means is further programmed to generate display data representative of a pathway between the two targets in the scene when generating the 3D guidance display data.

8. The head-mounted display device according to claim 1, further comprising a switchable source of illumination operably connected to the power means for supply, configured to excite the optical contrasting agent in the scene.

9. The head-mounted display device according to claim 1, wherein the data processing means further comprises a graphical processing unit (‘GPU’) programmed to generate 3D guidance display data according to the 3D guidance data, by reference to the one or more further geometrical datasets; and
wherein the data processing means is further adapted to output the 3D guidance display data to the graphical user interface.

10. The head-mounted display device according to claim 1, wherein the data processing means is further adapted to
determine a mismatch between the generated 3D guidance display data and the HMD wearer eye based on a distance measurement and a position of the wearer's eye, and
adjust a position of the generated guidance display data in the graphical user interface according to the determined mismatch; and optionally
wherein the distance measurement is performed based on stereoscopic image data or performed with an optional distance sensor of the HMD device.

11. The head-mounted display device according to claim 1, wherein the imaging means further generates eye pixel data representative of a respective eye of the HMD wearer in use, the device HMD further comprising—
at least a second parallel processing module configured with a plurality of eye pixel-respective data processing threads, adapted to—
filter eye pixel data with a predetermined value to segregate first eye pixel data from second eye pixel data, wherein the first eye pixel data is representative of at least a portion of the or each wearer's eye;
compute two-dimensional (2D) eye pixel coordinate data from the segregated first eye pixel data; and
wherein the data processing means is further adapted to—
transform 2D eye pixel coordinate data received from the or each second data parallel processing module into three-dimensional (3D) eye coordinate data representative of the wearer's eye focus relative to the device,
transform the 3D coordinate data by reference to the 3D eye coordinate data, and
generate the 3D guidance data according to transformed 3D coordinate data.

12. The head-mounted display device according to claim 11, wherein the data processing means is further adapted to
set the 2D eye coordinate data as a fixation point when generating the guidance display data; and
output the generated guidance display data to the graphical user interface as display data foveated according to the fixation point.

13. The head-mounted display device according to claim 1, wherein the parallel processing module is selected from the group comprising field programmable gate arrays (‘FPGA’), graphical processing units (‘GPU’), video processing units (‘VPU’), application specific integrated circuits (‘ASIC’), image signal processor (‘ISP’), digital signal processors (‘DSP’); alternatively
wherein the data processing means is selected from the group comprising hybrid programmable parallel-central processing units and configurable processors.

14. An image-based guidance system, comprising
at least one detectable target, one or more portions of which is configured with an optical contrasting agent; and
a head mounted display (HMD) device comprising
imaging means generating pixel data representative of a scene in use;
display means outputting a graphical user interface in use;
power means, data storage means storing geometrical datasets and data processing means operably interfaced with the imaging means and the display means, wherein the data processing means comprises—
at least one parallel processing module configured with a plurality of pixel-respective data processing threads, adapted to—
filter pixel data with a predetermined value to segregate first pixel data from second pixel data, wherein the first pixel data is representative of the one or more portions of the detectable target,
compute two-dimensional (2D) pixel coordinate data from segregated first pixel data; and
wherein the data processing means is further adapted to—
transform 2D pixel coordinate data by reference to a first geometrical dataset representative of at least one coordinate system originating at the HMD device, into three-dimensional (3D) coordinate data representative of the one or more portions of the detectable target,
generate 3D guidance data according to the 3D coordinate data, by reference to one or more further geometrical datasets, each representative of a respective detectable target in the scene, and
output the 3D guidance data to the graphical user interface.

15. The system according to claim 14, wherein the optical contrasting agent is an active agent emitting a light wave.

16. The system according to claim 14, wherein the optical contrasting agent is a passive agent, the system further comprising a source of illumination configured to excite the optical contrasting agent.

17. The system according to claim 16, wherein the HMD device comprises the source of illumination.

18. The system according to claim 14, wherein each of the one or more portions of the detectable target is a marker having a predetermined, relative geometric relationship therewith.

19. The system according to claim 18, wherein at least one detectable target is a tool in use by or proximate the HMD wearer, and at least one amongst the one or more further geometrical datasets comprises a three-dimensional model representative of the tool; and/or
wherein at least one detectable target is a marker defining a location in the scene, and at least one amongst the one or more further geometrical datasets comprises a three-dimensional model representative of the marker.

20. The system according to claim 19, wherein the marker is a matrix barcode, one or more portions of which is configured with the optical contrasting agent.

21. The system according to claim 19, wherein the scene comprises at least two detectable targets and wherein the data processing means is further programmed to generate display data representative of a pathway between the two detectable targets in the scene when generating the 3D guidance display data.

22. A method of guiding a detectable target with a head mounted display (HMD) device, comprising the steps of—
generating pixel data of a scene with imaging sensors of the HMD device, wherein the detectable target is in the scene,
with at least one parallel processing module of the HMD device, wherein the module is configured with a plurality of pixel-respective data processing threads,
filtering pixel data with a predetermined value to segregate first pixel data from second pixel data, wherein the first pixel data is representative of one or more portions of the detectable target configured with an optical contrasting agent,
computing two-dimensional (2D) pixel coordinate data from segregated first pixel data; and
with at least one further processing unit of the HMD device,
transform 2D pixel coordinate data by reference to a first geometrical dataset representative of at least one coordinate system originating at the HMD device, into three-dimensional (3D) coordinate data representative of the one or more portions of the detectable target, and
generating 3D guidance display data according to the 3D coordinate data, by reference to one or more further geometrical datasets, each representative of a respective detectable target in the scene; and
outputting the 3D guidance display data to a graphical user interface on at least one display of the HMD device.

23. The method according to claim 22, wherein the step of transforming further comprises triangulating the 2D pixel coordinate data by reference to the first geometrical dataset.

24. The method according to claim 22, wherein the step of transforming further comprises solving for rotation and translation based on the 2D pixel coordinate data.
